(19) United States
(12) Patent Application Publication
(10) Pub. No.: US 2008/0000063 A1
(43) Pub. Date: Jan. 3, 2008

(54) Component with a Filled Recess

(76) Inventors: Fathi Ahmad, Kaarst (DE); Michael Dankert, Offenbach (DE); Ying Pan, Essen (DE); Rostislav Teteruk, Mulheim an der Ruhr (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/791,101

(22) PCT Filed: Sep. 21, 2005
(86) PCT No.: PCT/EP05/54722

§ 371 Date: May 17, 2007

(30) Foreign Application Priority Data
Nov. 22, 2004 (EP) 04027671.9

(51) Int. Cl. B23P 6/04; F01D 5/00

(52) U.S. Cl. 29/402.18

(57) ABSTRACT

According to a prior art, components having a crack are repaired, wherein the thus produced elongated recess is filled with a solder material which nevertheless produces a weak point. The inventive component, in addition to the material filled recess, comprises an additional material filled recess which extends transversely to the longitudinal direction of the cavity.

### CROSS REFERENCE TO RELATED APPLICATIONS

This application is the US National Stage of International Application No. PCT/EP2005/054722, filed Sep. 21, 2005 and claims the benefit thereof. The International Application claims the benefits of European application No. 04027671.9 filed Nov. 22, 2004, both of the applications are incorporated by reference herein in their entirety.

### FIELD OF INVENTION

The invention relates to a component with a filled recess in accordance with the claims.

### BACKGROUND OF THE INVENTION

On occasions after production or often after prolonged use, components have cracks. These cracks are assessed, and depending on the assessment the component can be used or reused or may be separated out as unusable.

If the crack length or defect size has exceeded a critical level, material is machined out around the crack and the recess which is formed is filled with a solder. However, in operational use, in particular because the solder has worse thermomechanical properties than the original material, a crack may form again at this location, leading to component failure, in particular in a relatively short time, since the crack can propagate more quickly through the weaker material than when the initial crack was formed.

### SUMMARY OF INVENTION

Therefore, it is an object of the invention to provide a component which overcomes this drawback.

The object is achieved by the component as claimed in the claims. The subclaims list further advantageous configurations of the component, which can advantageously be combined with one another in any desired way.

The idea of the invention consists, inter alia, in material being machined out, for example by milling, around the elongate crack not just in the direction in which the crack extends but also in a direction that is transverse with respect to the crack and in which the crack did not originally extend.

### BRIEF DESCRIPTION OF THE DRAWINGS

In the drawing:

FIG. 1 shows a component with a crack,

FIG. 2 shows a repaired component according to the prior art,

FIGS. 3 to 16 show exemplary embodiments of the component according to the invention,

FIG. 17 shows a turbine blade or vane,

FIG. 18 shows a combustion chamber,

FIG. 19 shows a turbine.

### DETAILED DESCRIPTION OF INVENTION

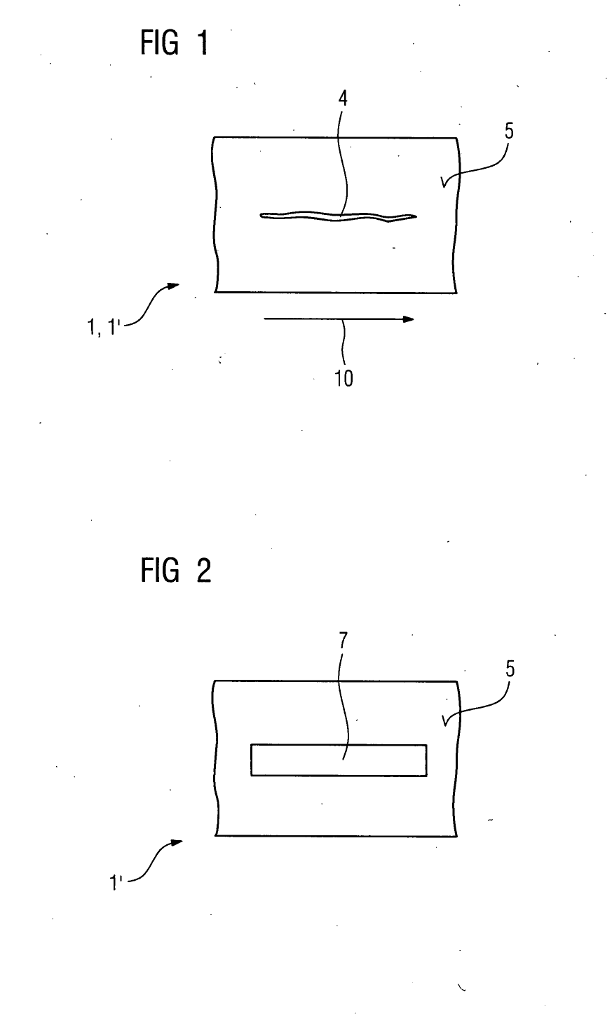

FIG. 1 shows a component 1, 1′ having a surface 5, in or below which a crack 4 extends in a direction of extent 10.

FIG. 2 shows a component 1′ according to the prior art which has been repaired. Starting from the state shown in FIG. 1, material is machined out around the crack 4 on both sides along the extent of the crack, so as to form an elongate recess 7 which completely surrounds the original crack and is then filled with a material (for example solder) which for example differs from the material of the component 1. Like the crack 4, the recess 7 has an elongate shape (rectangular) in the direction of extent 10.

Alternatively, however, the recess 7 may have been formed as early as during production of the component, as is customary for example when casting components, in which a recess 7 is present in the component where a support was present in the casting mold, i.e. the recess 7 in the component need not necessarily be arranged at a location at which a crack was previously present.

The component 1 comprises a first material, which is identical or of similar type to the second material in the recess 7 (for example in the case of welding) or is different than said second material (for example in the case of soldering).

The second material, for example, by virtue of having a different microstructure, has worse thermomechanical properties than the component, which for example has a DS or SX structure. Different microstructures are produced when soldering or welding or welding using weld material of the same component as the base material.

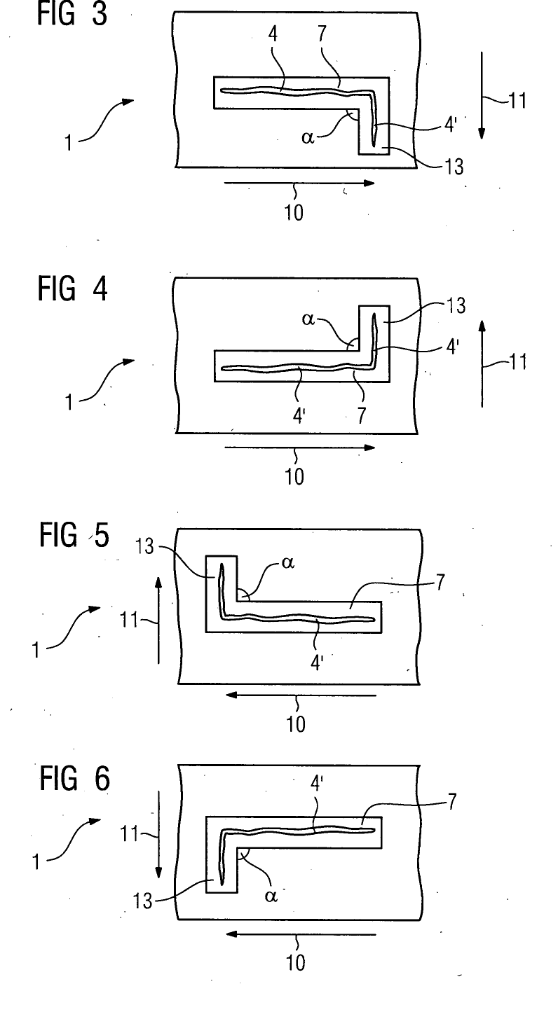

FIGS. 3 to 6 show exemplary embodiments of the component 1 according to the invention. The recess 7 extends not only in the direction of extent 10 but also in a transverse direction 11 that is transverse to the direction 10 and, unlike in FIG. 2, is not rectangular in contour, but rather L-shaped. The additional, transversely extending part of the recess 7, the additional recess 13, is in this case, by way of example, likewise rectangular in form.

Both the original part of the recess 7 according to the prior art and the additional recess 13 may also be round rather than rectangular. For example, the original part of the recess 7 according to the prior art may have an elongate oval contour.

The additional recess 13 may extend at an angle α of from >0° to <180° with respect to the direction of extent 10. α is preferably ≧45°, ≧60°, ≧75° or 90°.

The L shape may be present in any desired orientation in the component 1 (FIGS. 3-6). The recess 7 is then for example filled with a solder or welded shut using a second material. This material generally differs from the material of the component 1 (superalloy, in particular based on nickel, cobalt or iron), but in any event has worse thermomechanical properties than the base material of the component 1.

Should a crack 4′ form for the first time or again in the filled recess 7, this crack is diverted into the additional recess 13 (FIGS. 3-6) and is thereby isolated from the stress present on the component 1, with the result that the crack 4′ does not continue to grow. Consequently, the transversely running additional recess 13 has the function of a crack stopper which can divert the crack propagation into a direction to which the mechanical stresses which are present are not critical.

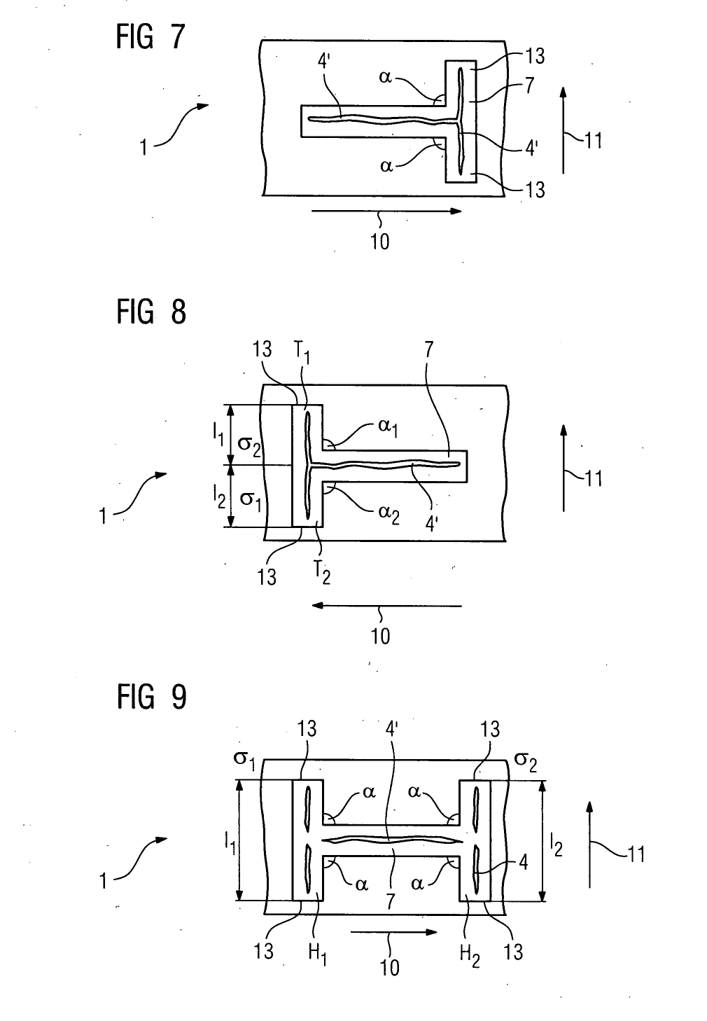

In FIGS. 7, 8, the recess 7 is of T-shaped design. Should a crack 4′ again form in the recess 7 longitudinally with respect to direction 10, it is diverted to the left and/or right in transverse direction 11.

FIG. 8 illustrates a further advantageous configuration of the invention.

The T shape has a first T region T₁, which extends in the transverse direction 11, and a second T region T₂, which extends in the opposite direction to the transverse direction 11. The corresponding lengths l₁, l₂ of the regions T₁, T₂ may be equal.

However, if, in operational use of the component 1, different stresses σ₁, σ₂ are present in the regions T₁, T₂, it is advantageous for the length l₂ to be correspondingly longer than the length l₁ if stress σ₂ is greater than σ₁.

FIG. 9 shows an H shape of the recess 7 as a further particularly advantageous form of the invention.

In the transverse direction 11, the H shape has a first and a second H region H₁ and H₂, respectively, with corresponding lengths l₁, l₂.

The lengths l₁, l₂ may be identical. If, as seen in the direction of extent 10, a greater stress σ₁ is present in region H₁ than the stress σ₂ in region H₂, it is advantageous for the length l₁ to be corresponding longer than the length l₂ of region H₂.

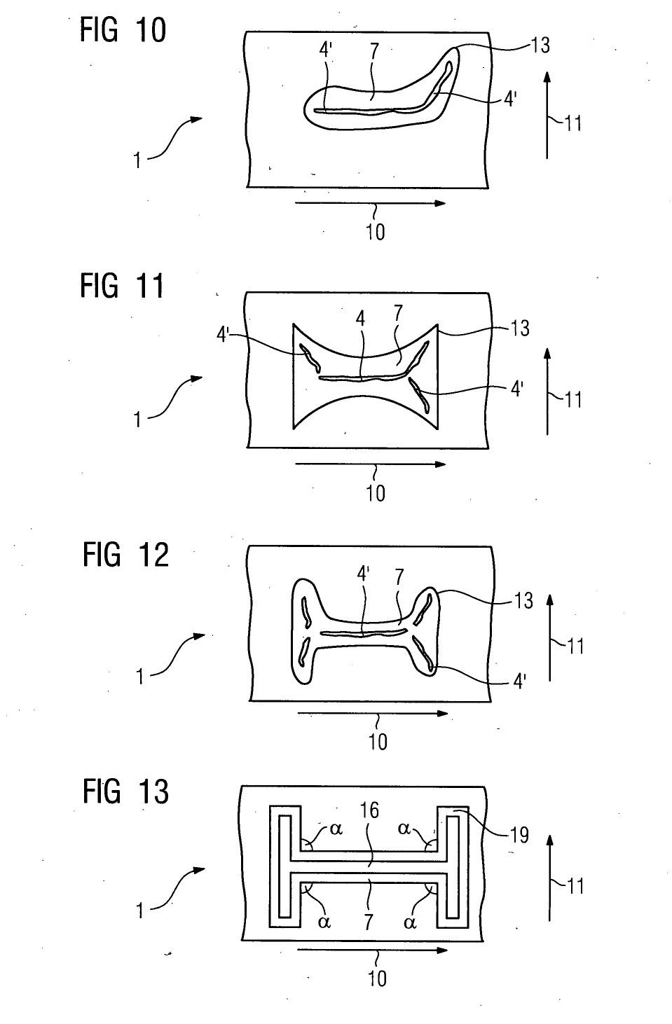

Instead of angling off on a straight line, the additional recess 13 may also be curved in the form of an arc with respect to direction 10 and may taper to a point or be rounded at the end, as shown in FIG. 10.

An additional recess 13 of this type may be designed in an L shape (FIG. 10), a T shape or H shape (FIG. 11).

It is also possible for the contour of the H shape to be rounded in the corner regions, so as to adopt the shape of a bone (FIG. 12).

FIG. 13 shows a further exemplary embodiment of the component 1 according to the invention.

In this example, the recess 7 (illustrated here by way of example in the shape of an H) has been filled with an insert 16 and a solder 19. The insert 16 has in particular the contour of the recess 7 and consists for example of the same material as the component 1 and is held in place by the solder 19 in the recess 7 or is welded to the component 1.

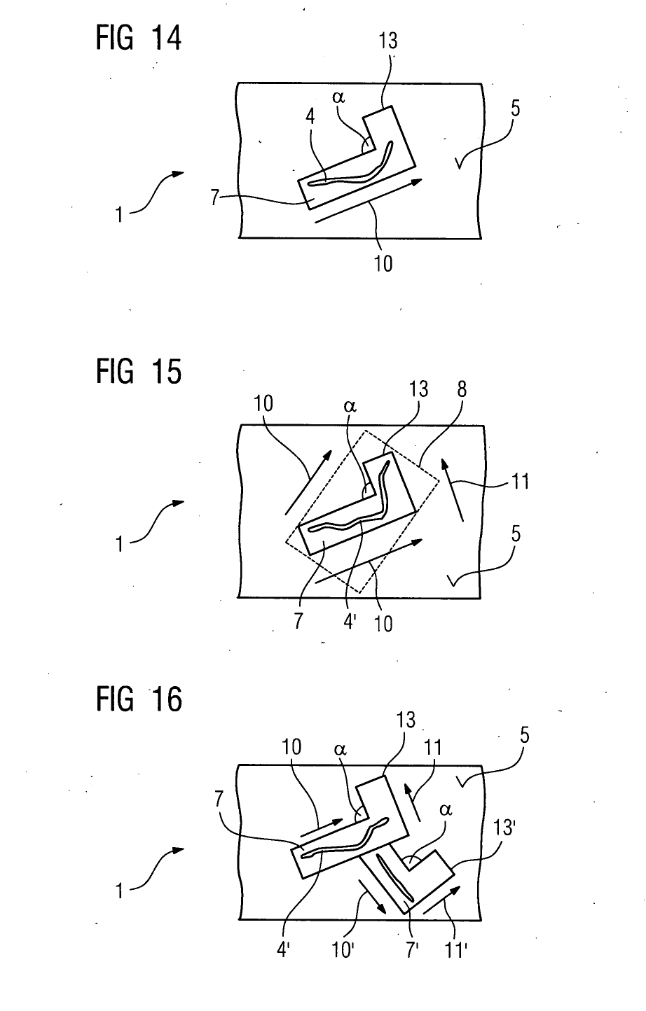

The recess 7 is in particular formed in such a way that it encompasses the entire crack 4, even if said crack 4 does not always run in a straight line in the direction of extent 10 (FIG. 14). According to the prior art, this can give rise to a very wide recess 8 (as indicated by dashed lines in FIG. 15) if the crack 4 propagates not only in a direction of extent 10 but also transversely to the direction of extent 10. According to the invention, the recess 7 with the additional recess 13 is once again for example of L-shaped design, with the L shape rotated with respect to the crack 4 in such a way that much less material has to be removed compared to the recess 8 of the prior art (FIG. 15).

The component 1 may of course have a plurality of cracks 4 at vulnerable locations, with these cracks extending in different directions of extent 10, 10′ (FIG. 16). In this event, a recess 7, 7′ according to the invention with the additional recess 13, 13′ is formed at each crack.

However, it is also possible for a crack 4 to have forked, for example, as illustrated in FIG. 16. In this case, for example with the crack profile illustrated in FIG. 16, it is once again possible to match an L shape to the crack, or alternatively two L shapes are used, matched to the two different branches of the crack, in which case the two recesses 7, 7′ for example also touch or partly overlap one another.

The component 1 may be a turbine blade or vane 120, 130 of a turbine, for example of a steam turbine or a gas turbine 100 for a power plant, or of an aircraft, or a heat shield element 155.

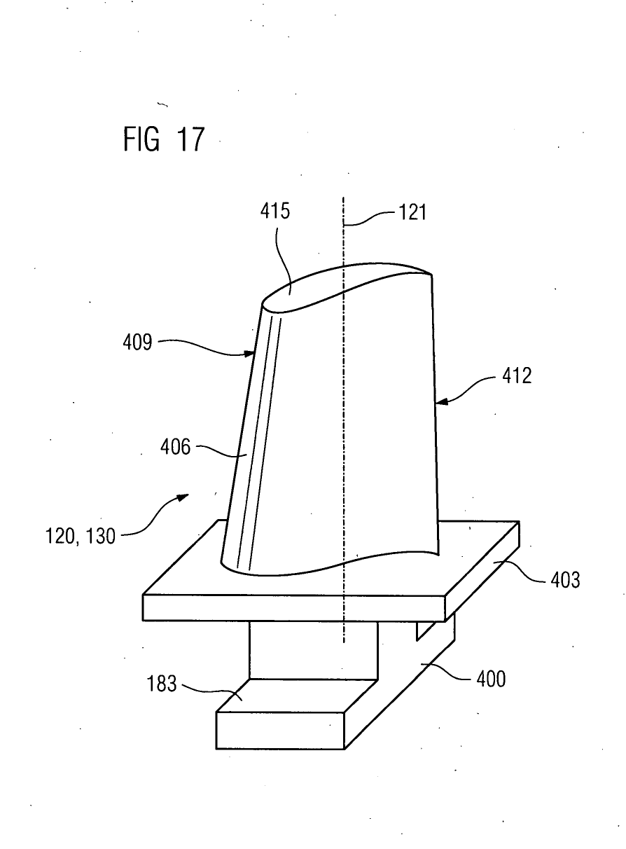

FIG. 17 shows a perspective view of a blade or vane 120, 130, which extends along a longitudinal axis 121.

The blade or vane 120 may be a rotor blade 120 or a guide vane 130 of a turbomachine. The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406. As a guide vane 130, the vane 130 may have a further platform (not shown) at its vane tip 415. A blade or vane root 183, which is used to secure the rotor blades 120, 130 to a shaft or a disk (not shown), is formed in the securing region 400. The blade or vane root 183 is designed, for example, in hammerhead form. Other configurations, such as a fir-tree or dovetail root, are possible. The blade or vane 120, 130 has a leading edge 409 and a trailing edge 412 for a medium which flows past the main blade or vane part 406.

In the case of conventional blades or vanes 120, 130, by way of example solid metallic materials are used in all regions 400, 403, 406 of the blade or vane 120, 130. The blade or vane 120, 130 may in this case be produced by a casting process, also by means of directional solidification, by a forging process, by a milling process or combinations thereof.

Workpieces with a single-crystal structure or structures are used as components for machines which, in operation, are exposed to high mechanical, thermal and/or chemical stresses. Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired, as described in FIGS. 3-13. This is followed by recoating of the component 120, 130, after which the component 120, 130 can be reused.

The blade or vane 120, 130 may be hollow or solid in form. If the blade or vane 120, 130 is to be cooled, it is hollow and may also have film-cooling holes (not shown). To protect against corrosion, the blade or vane 120, 130 has, for example, generally metallic coatings, and to protect against heat it generally also has a ceramic coating.

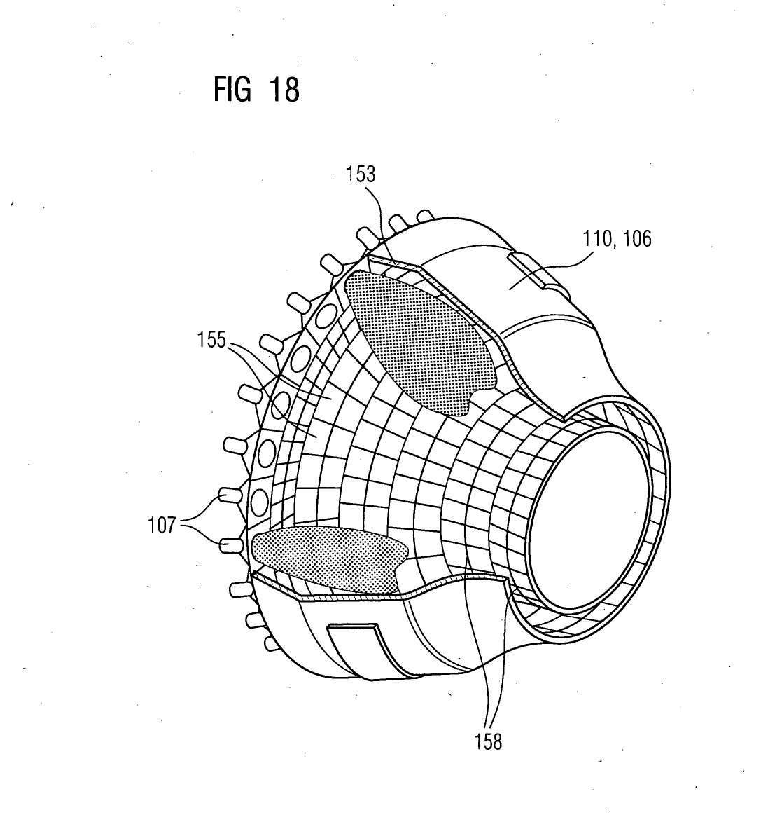

FIG. 18 shows a combustion chamber 110 of a gas turbine 100. The combustion chamber 110 is configured, for example, as what is known as an annular combustion chamber, in which a multiplicity of burners 102 arranged circumferentially around the turbine shaft 103 open out into a common combustion chamber space. For this purpose, the combustion chamber 110 overall is of annular configuration positioned around the turbine shaft 103.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155 (as a further example of a component 1). On the working medium side, each heat shield element 155 is equipped with a particularly heat-resistant protective layer or is made from a material that is able to withstand high temperatures. On account of the high temperatures in the interior of the combustion chamber 110, a cooling system is also provided for the heat shield elements 155 and/or for their holding elements.

The materials of the combustion chamber wall and their coatings may be similar to those of the turbine blades or vanes.

The combustion chamber 110 is designed in particular to detect losses of the heat shield elements 155. For this purpose, a number of temperature sensors 158 are positioned between the combustion chamber wall 153 and the heat shield elements 155.

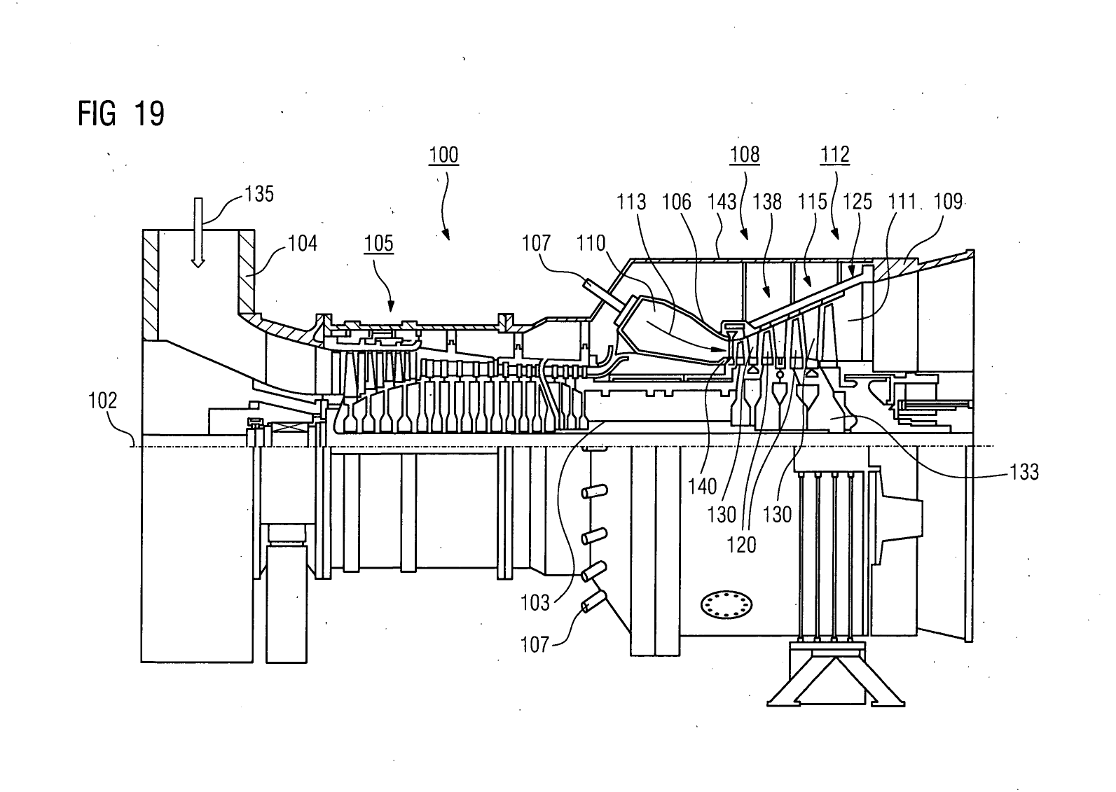

FIG. 19 shows, by way of example, a partial longitudinal section through a gas turbine 100. In the interior, the gas turbine 100 has a rotor 103 which is mounted such that it can rotate about an axis of rotation 102 and is also referred to as the turbine rotor.

An intake housing 104, a compressor 105, a, for example, toroidal combustion chamber 110, in particular an annular combustion chamber 106, with a plurality of coaxially arranged burners 107, a turbine 108 and the exhaust-gas housing 109 follow one another along the rotor 103.

The annular combustion chamber 106 is in communication with a, for example, annular hot-gas passage 111, where, by way of example, four successive turbine stages 112 form the turbine 108. Each turbine stage 112 is formed, for example, from two blade or vane rings. As seen in the direction of flow of a working medium 113, in the hot-gas passage 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133. A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield bricks which line the annular combustion chamber 106, are subject to the highest thermal stresses.

To be able to withstand the temperatures which prevail there, they may be cooled by means of a coolant. Substrates of the components may likewise have a directional structure, i.e. they are in single-crystal form (SX structure) or have only longitudinally oriented grains (DS structure).

By way of example, iron-base, nickel-base or cobalt-base superalloys are used as material for the components, in particular for the turbine blade or vane 120, 130 and components of the combustion chamber 110. Superalloys of this type are known, for example, from EP 1204776, EP 1306454, EP 1319729, WO 99/67435 or WO 00/44949; these documents form part of the disclosure.

The blades or vanes 120, 130 may also have coatings which protect against corrosion (MCrAlX; M is at least one element selected from the group consisting of iron (Fe), cobalt (Co), nickel (Ni), X is an active element and represents yttrium (Y) and/or silicon and/or at least one rare earth element) and heat by means of a thermal barrier coating.

The thermal barrier coating consists, for example, of ZrO₂, Y₂O₄-ZrO₂, i.e. unstabilized, partially stabilized or fully stabilized by yttrium oxide and/or calcium oxide and/or magnesium oxide. Columnar grains are produced in the thermal barrier coating by suitable coating processes, such as for example electron beam physical vapor deposition (EB-PVD).

The guide vane 130 has a guide vane root (not shown here) which faces the inner housing 138 of the turbine 108, and a guide vane head which is at the opposite end from the guide vane root. The guide vane head faces the rotor 103 and is fixed to a securing ring 140 of the stator 143.

1.-16. (canceled)

17. A process for repairing a component formed from a first material having a crack oriented in a direction of extent and of elongate shape, comprising:
machining a first recess along the extent of the crack;
machining a second recess at an angle with respect to the direction of extent; and
filling the first and second recesses with a second material.

18. The process as claimed in claim 17, wherein the second material is a solder material or a welding filler material.

19. The process as claimed in claim 17, wherein the first and second recesses form an L-shape.

20. The process as claimed in claim 17, wherein the first and second recesses form a T-shape.

21. The process as claimed in claim 20, wherein the T shape has a first T region and a second T region transverse to the direction of extent and having a first respective length greater than a second respective length if a first operative stress active in the first region during operation is greater than a second operative stress active in the second region during operation.

22. The process as claimed in claim 17, wherein the first and second recesses form an H-shape.

23. The process as claimed in claim 22, wherein the H shape, in a direction transverse with respect to the direction of extent, has:
a first H region having a first length and a first operative stress present during operation, and
a second H region having a second length in the transverse direction and a second operative stress present during operation, where the first length is greater than the second length if the first stress is greater than the second stress.

24. The process as claimed in claim 17, wherein the second recess is oriented at an angle of at least 45° with respect to the direction of extent.

25. The process as claimed in claim 24, wherein the angle is at least 60°.

26. The process as claimed in claim 24, wherein the angle is at least 75°.

27. The process as claimed in claim 24, wherein the angle is at least or equal to 90°.

28. The process as claimed claim 17, wherein the recess is formed at a location where a crack was present.

29. The process as claimed in claim 17, wherein the first and second materials are the same.

30. The process as claimed in claim 29, wherein the first material is a nickel, cobalt or iron based superalloy.

31. The process as claimed in claim 17, wherein the first material has a different microstructure than the second material.

32. The process as claimed in claim 17, wherein the first material is different than the second material.

33. The process as claimed in claim 17, wherein the component is a blade, vane or heat shield element of a gas turbine.
